(19) United States
(12) Patent Application Publication
(10) Pub. No.: US 2018/0165731 A1
(43) Pub. Date: Jun. 14, 2018

(54) METHOD AND SYSTEM FOR REAL TIME RIDESHARING MANAGEMENT

(71) Applicant: Conduent Business Services, LLC, Dallas, TX (US)

(72) Inventors: Ragavendran Gopalakrishnan, Bangalore (IN); Arpita Biswas, Kolkata (IN); Asmita Metrewar, Nanded (IN); Koyel Mukherjee, Bangalore (IN); Raja Subramaniam Thangaraj, Kulithalai (IN)

(21) Appl. No.: 15/373,744

(22) Filed: Dec. 9, 2016

(51) Int. Cl. G06Q 30/06; G01C 21/34; G06Q 50/30

(52) U.S. Cl. CPC G06Q 30/0605; G06Q 50/30; G01C 21/3438

(57) ABSTRACT

The disclosed embodiments illustrate methods of data processing for ridesharing management. The method includes receiving a first plurality of ridesharing requests from a first plurality of commuter-computing devices. A ridesharing request of the first plurality of ridesharing requests comprises at least a set of commuter constraints. The method further includes identifying a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests. The method further includes determining an adaptive detour discount factor associated with the identified ridesharing vehicle. The method includes updating the maximized key performance parameter for matched ridesharing requests in a second plurality of ridesharing requests from a second plurality of commuters based on at least the determined adaptive detour discount factor.

### TECHNICAL FIELD

The presently disclosed embodiments are related, in general, to ridesharing services. More particularly, the presently disclosed embodiments are related to methods and systems for ridesharing management.

### BACKGROUND

Recent developments in the field of transportation services have led to the evolution of online platforms that may cater to various traveling requirements of a user. Specifically, in case of private transportation services, ridesharing vehicles have emerged as a popular solution to combat ever-increasing congestion along road networks around the world.

Typically, ridesharing vehicles specify a routing scheme and a pricing scheme for commuters. In accordance with the routing scheme, the incoming ridesharing requests are grouped into ridesharing groups and subsequent computation of optimal routes for the ridesharing groups is performed. Usually, the commuters are charged based on the distance traveled in the ridesharing vehicle. However, in certain scenarios, various incentives, such as discount offers, are given to commuters for opting the ridesharing vehicle rather than a dedicated vehicle. Such incentives increase the likelihood of commuters to opt for the ridesharing vehicle for traveling. However, the increase in the likelihood of commuters opting for the ridesharing vehicle is at the cost of decreased profit of the service provider of the ridesharing vehicle. Thus, a robust method and system is required that not only aims at increasing the likelihood of commuters to opt for the ridesharing vehicle but also optimizes the profit earned by the service provider of the ridesharing vehicle.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method of data processing by a computing device for ridesharing management. The method includes receiving, by one or more transceivers in the computing device, a first plurality of ridesharing requests of a first plurality of commuters from a first plurality of commuter-computing devices. A ridesharing request of the first plurality of ridesharing requests comprises at least a set of commuter constraints. The method further includes identifying, by one or more processors in the computing device, a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle. The method further includes determining, by the one or more processors, an adaptive detour discount factor associated with the identified ridesharing vehicle based on the maximized key performance parameter. The method further includes updating, by the one or more processors, the maximized key performance parameter for matched ridesharing requests in a second plurality of ridesharing requests from a second plurality of commuters based on at least the determined adaptive detour discount factor. The determined adaptive detour discount factor is rendered on a display-screen of a second plurality of commuter-computing devices associated with the second plurality of commuters.

According to embodiments illustrated herein, there is provided a system for data processing, by a computing device, for ridesharing management. The system includes one or more processors in the computing device configured to receive a first plurality of ridesharing requests of a first plurality of commuters, by use of one or more transceivers in the computing device, from a first plurality of commuter-computing devices. A ridesharing request of the first plurality of ridesharing requests comprises at least a set of commuter constraints. The one or more processors are further configured to identify a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle. The one or more processors are further configured to determine an adaptive detour discount factor associated with the identified ridesharing vehicle based on the maximized key performance parameter. Further, the one or more processors are configured to update the maximized key performance parameter for matched ridesharing requests in a second plurality of ridesharing requests from the second plurality of commuters based on at least the determined adaptive detour discount factor. The determined adaptive detour discount factor is rendered on a display-screen of a second plurality of commuter-computing devices associated with the second plurality of commuters.

According to embodiments illustrated herein, there is provided a computer program product for use with a computing device. The computer program product comprises a non-transitory computer readable medium storing a computer program code for data processing for real time ridesharing management. The computer program code is executable by one or more processors in a computing device to receive a first plurality of ridesharing requests of a first plurality of commuters from a first plurality of commuter-computing devices. A ridesharing request of the first plurality of ridesharing requests comprises at least a set of commuter constraints. The computer program code is further executable by the one or more processors to identify a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle. The computer program code is further executable by the one or more processors to determine an adaptive detour discount factor associated with the identified ridesharing vehicle based on the maximized key performance parameter. The computer program code is further executable by the one or more processors to update the maximized key performance parameter for matched ridesharing requests in a second plurality of ridesharing requests from the second plurality of commuters based on at least the determined adaptive detour discount factor. The determined adaptive detour discount factor is rendered on a display-screen of a second plurality of commuter-computing devices associated with the second plurality of commuters.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates an application server, in accordance with at least one embodiment;

FIG. 3 depicts a flowchart that illustrates a method for real time management of ridesharing services, in accordance with at least one embodiment;

FIG. 4 is a block diagram that illustrates an exemplary scenario for real time management of ridesharing services, in accordance with at least one embodiment; and

FIG. 5 illustrates an exemplary graphical user-interface (GUI) presented on a commuter-computing device of a commuter to facilitate real time management of ridesharing services, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “commuter-computing device” refers to a computer, a device (that includes one or more processors/microcontrollers and/or any other electronic components), or a system (that performs one or more operations according to one or more programming instructions/codes) associated with a user, such as a commuter. In an embodiment, the commuter-computing device may be utilized by the commuter to transmit a ridesharing request. Examples of the commuter-computing device may include, but are not limited to, a laptop, a personal digital assistant (PDA), a mobile device, a smartphone, and a tablet computer (e.g., iPad® and Samsung Galaxy Tab®).

A “ridesharing request” refers to a request raised by a commuter who may want to commute from a source location to a destination location in a ridesharing vehicle. In an embodiment, the ridesharing request may comprise the source location, the destination location, and a set of commuter constraints, such as a waiting time threshold a detour distance threshold, and a detour time threshold, and/or the like. For example, a user may raise a ridesharing request to travel from a source location “S” to a destination location “D” at “10:00 a.m.”

A “ridesharing vehicle” in a plurality of ridesharing vehicles corresponds to a vehicle that is offered by a service provider for ridesharing. In an embodiment, the ridesharing vehicle may be identified to serve a plurality of ridesharing requests of a plurality of commuters based on a set of commuter constraints and a set of vehicle constraints. For example, a vehicle “V1” may be identified to serve ridesharing requests of “three” commuters simultaneously.

“Matched ridesharing requests” refer to ridesharing requests that can be merged together to be served simultaneously by a same ridesharing vehicle. In an embodiment, the ridesharing requests may be matched based on a set of commuter constraints and a set of vehicle constraints. For example, a ridesharing request “R1” and another ridesharing request “R2” can be merged together to be served simultaneously by a same ridesharing vehicle “V1.” The ridesharing vehicle “V1” may pick up the commuter associated with the ridesharing request “R1” and proceed further to pick up the commuter associated with the ridesharing request “R2.” Thus, the commuter associated with the ridesharing request “R1” and the commuter associated with the ridesharing request “R2” may correspond to co-commuters for the ridesharing vehicle “V1.”

A “set of commuter constraints” refers to constraints specified by a commuter in a ridesharing request. In an embodiment, the set of commuter constraints may comprise a waiting time threshold, a detour distance threshold, and a detour time threshold. In an embodiment, the waiting time threshold may refer to a maximum time interval after raising the ridesharing request for which the commuter is willing to wait for a pick up by a ridesharing vehicle. In an embodiment, the detour distance threshold may refer to a maximum extra distance the commuter is willing to travel in the ridesharing vehicle due to a ridesharing request of another commuter. In an embodiment, the detour time threshold may refer to a maximum extra time for which the commuter is willing to travel in the ridesharing vehicle due to a ridesharing request of another commuter.

A “set of vehicle constraints” refers to constraints associated with a ridesharing vehicle. In an embodiment, the set of vehicle constraints may include a capacity constraint of the ridesharing vehicle. For example, the vehicle capacity of a ridesharing vehicle may be “four.” Thus, the ridesharing vehicle may serve a maximum of “four” requests simultaneously. Further, based on the vehicle capacity, the ridesharing vehicle may not be identified for more than “four” ridesharing requests at a given time instant. Thus, “four” ridesharing requests may correspond to the capacity constraint of the ridesharing vehicle.

A “first plurality of ridesharing requests” refers to ridesharing requests raised by a first plurality of commuters. A plurality of ridesharing requests that is received before determining of an adaptive detour discount factor may correspond to the first plurality of ridesharing requests. For example, the adaptive detour discount factor may be determined after “t” days. Thus, the plurality of ridesharing requests that is received before the completion of “t” days may correspond to the first plurality of ridesharing requests.

A “second plurality of ridesharing requests” refers to ridesharing requests raised by a second plurality of commuters. A plurality of ridesharing requests that is received after determining of an adaptive detour discount factor may correspond to the second plurality of ridesharing requests. For example, the adaptive detour discount factor may be determined after “t” days. Thus, the plurality of ridesharing requests that is received after the completion of “t” days may correspond to the second plurality of ridesharing requests.

A “profitability parameter” refers to profit earned by a service provider of a ridesharing vehicle by serving a plurality of ridesharing requests of a plurality of commuters. In an embodiment, the profitability parameter may be determined based on a fare charged to the plurality of commuters associated with the plurality of ridesharing requests and a wage parameter of a driver of the ridesharing vehicle.

A “key performance parameter” refers to a performance parameter, associated with a ridesharing vehicle, which a service provider of the ridesharing vehicle is willing to optimize. For instance, profit earned by the service provider of the ridesharing vehicle may correspond to a key performance parameter. In this scenario, the optimization of the key performance parameter may correspond to a maximization of the key performance parameter. In another instance, a number of driver-miles for serving a plurality of commuters may correspond to another key performance parameter. In such scenario, the optimization of the other key performance parameter may correspond to a minimization of the other key performance parameter.

An “adaptive detour discount factor” refers to a dynamic discount factor based on which a discount is provided to a commuter for sharing a vehicle with another commuter. In an embodiment, the adaptive detour discount factor is a function of detour distance and detour time. Thus, a commuter may be compensated for an extra time and distance traveled in a ridesharing vehicle due to a ridesharing request of another commuter served by the ridesharing vehicle. In an embodiment, the adaptive detour discount factor may be updated in real time to optimize (i.e., maximize or minimize) a key performance parameter as specified by the service provider of the ridesharing vehicle. However, a person having ordinary skill in the art will appreciate that the usage of words, such as minimize, maximize, optimize, and/or any other similar words, in the disclosure are to be construed broadly within the ongoing practical context, and should not be construed as yielding a provable mathematical maximum or optimum solution.

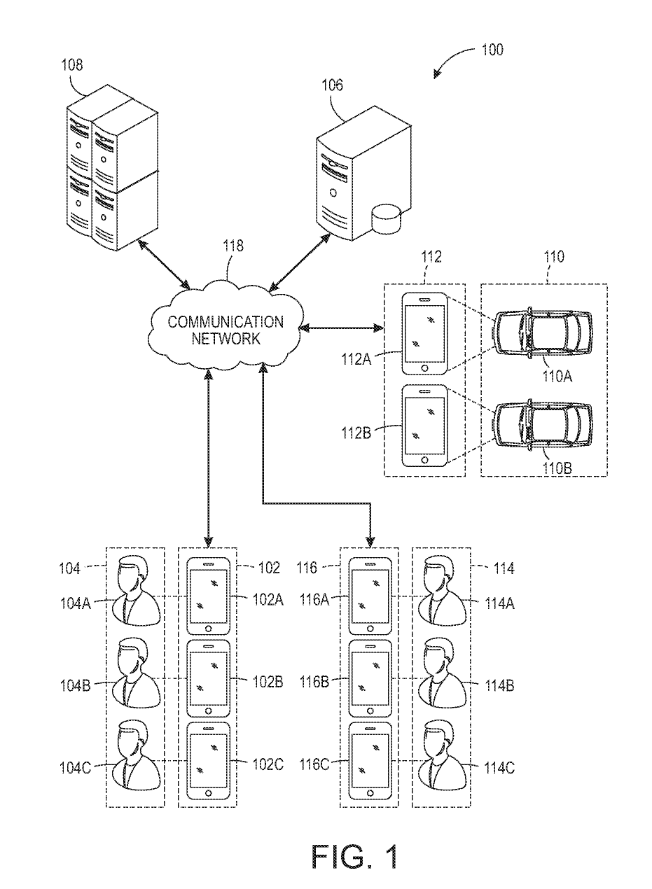

FIG. 1 is a block diagram of a system environment in which various embodiments may be implemented. With reference to FIG. 1, there is shown a system environment 100 that includes a first plurality of commuter-computing devices 102 associated with a first plurality of commuters 104. The first plurality of commuter-computing devices 102 further includes commuter-computing devices 102A to 102C and the first plurality of commuters 104 includes commuters 104A to 104C. The system environment 100 further includes a database server 106, an application server 108, and a plurality of ridesharing vehicles 110 associated with a plurality of vehicle-computing devices 112. The plurality of ridesharing vehicles 110 includes a first ridesharing vehicle 110A and a second ridesharing vehicle 110B, and the plurality of vehicle-computing devices 112 includes a first vehicle-computing device 112A and a second vehicle-computing device 112B. The system environment 100 further includes a second plurality of commuters 114 associated with a second plurality of commuter-computing devices 116. The second plurality of commuters 114 may include commuters 114A to 114C and the second plurality of commuter-computing devices 116 includes commuter-computing devices 116A to 116C. The system environment 100 further includes a communication network 118.

Various devices in the system environment 100 may be interconnected over the communication network 118. FIG. 1 shows, for simplicity, three commuter-computing devices (such as the commuter-computing devices 102A to 102C, in the first plurality of commuter-computing devices 102), three commuters (such as the commuters 104A to 104C, in the first plurality of commuters 104), one database server (such as the database server 106), and one application server (such as the application server 108). FIG. 1 further shows, for simplicity, two ridesharing vehicles (such as the first ridesharing vehicle 110A and the second ridesharing vehicle 110B), two vehicle-computing devices (such as the first vehicle-computing device 112A and the second vehicle-computing device 112B), three commuters (such as the commuters 114A to 114C, in the second plurality of commuters 114), and three commuter-computing devices (such as the commuter-computing devices 116A to 116C, in the second plurality of commuter-computing devices 116). However, it will be apparent to a person having ordinary skill in the art that the disclosed embodiments may also be implemented using multiple commuters, multiple commuter-computing devices, multiple database servers, multiple application servers, multiple ridesharing vehicles, and multiple vehicles computing devices, without departing from the scope of the disclosure.

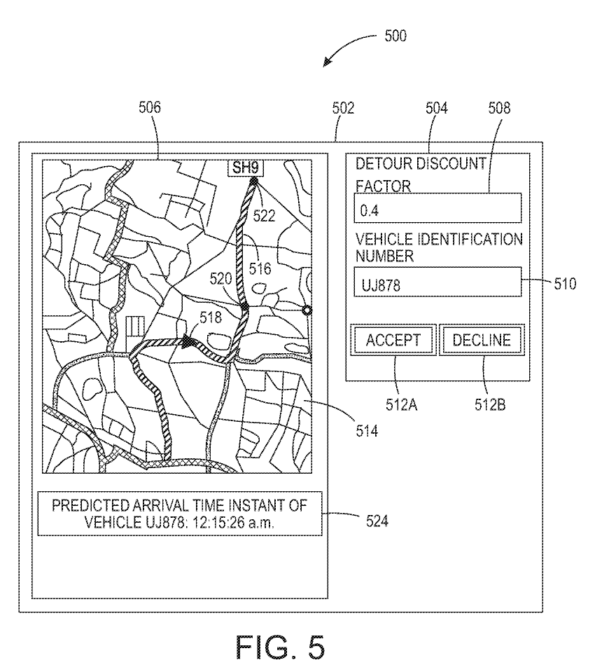

Each commuter-computing device, such as the commuter-computing devices 102A to 102C, of the first plurality of commuter-computing devices 102 may refer to a computing device that may be communicatively coupled to the communication network 118. Each commuter-computing device, such as the commuter-computing devices 102A to 102C, may comprise one or more processors and one or more memory devices. The one or more memory devices may include computer readable codes and instructions that may be executable by the one or more processors to perform one or more predetermined operations. In an embodiment, each commuter-computing device, such as the commuter-computing devices 102A to 102C, may be associated with a commuter in the first plurality of commuters 104. For instance, the commuter-computing device 102A of the first plurality of commuter-computing devices 102 may be associated with the commuter 104A of the first plurality of commuters 104. The commuter-computing device 1028 of the first plurality of commuter-computing devices 102 may be associated with the commuter 104B of the first plurality of commuters 104, Further, the commuter-computing device 102C of the first plurality of commuter-computing devices 102 may be associated with the commuter 104C of the first plurality of commuters 104. In an embodiment, each commuter-computing device, such as the commuter-computing devices 102A to 102C, may be used by the corresponding commuter to raise a ridesharing request. In other words, the first plurality of commuter-computing devices 102 may be used by the first plurality of commuters 104 to raise a first plurality of ridesharing requests. Further, each commuter-computing device, such as the commuter-computing devices 102A to 102C, may be configured to receive a notification from the application server 108, over the communication network 118, in response to the ridesharing request raised by the corresponding commuter. The notification may be rendered in form of an interactive graphical user-interface (GUI) on a display screen of each commuter-computing devices, such as commuter-computing devices 102A to 102C, in the first plurality of commuter-computing devices 102. An example of the interactive GUI rendered on a mobile computing device is described later in FIG. 5.

Each commuter-computing device, such as the commuter-computing devices 102A to 102C, in the first plurality of commuter-computing devices 102 may correspond to a variety of computing devices, such as, but not limited to, a laptop, a PDA, a tablet computer, a smartphone, and a phablet.

Each commuter, such as the commuters 104A to 104C, in the first plurality of commuters 104 may refer to an individual who may raise a ridesharing request by using the corresponding commuter-computing device in the first plurality of commuter-computing devices 102. For instance, the commuter 104A may use the commuter-computing device 102A to raise the ridesharing request to commute from a source location to a destination location. In an embodiment, for each commuter, such as the commuters 104A to 104C, in the first plurality of commuters 104, a commuter profile may be created at the time of registration with a ridesharing service platform associated with the application server 108. In another embodiment, the commuter profile of each commuter, such as the commuters 104A to 104C, may be created when he/she raises the ridesharing request for the first time. In an embodiment, a commuter may provide corresponding commuter profile, which may comprise details, such as a set of commuter constraints, pertaining to the commuter. In an embodiment, the commuter profile of the commuter may be retrieved from one or more social networking websites. In an embodiment, the received/retrieved commuter profile of each commuter, such as the commuters 104A to 104C, may be stored in the database server 106. In an embodiment, after raising the ridesharing request each commuter in the first plurality of commuters 104 may wait at the corresponding source location for pick up by a ridesharing vehicle, such as the first ridesharing vehicle 110A or the second ridesharing vehicle 110B.

The database server 106 may refer to a computing device that may be communicatively coupled to the communication network 118. In an embodiment, the database server 106 may be configured to perform one or more database operations. The one or more database operations may include one or more of, but not limited to, receiving, storing, processing, and transmitting one or more queries, data, or content. The one or more queries, data, or content may be received/transmitted from/to various components of the system environment 100. In an embodiment, the database server 106 may be configured to store the commuter profiles of plurality of commuters, such as the first plurality of commuters 104 and the second plurality of commuters 114. In an embodiment, the database server 106 may be further configured to store geographical map data of an area. In an embodiment, the database server 106 may be configured to receive one or more queries from the application server 108 for the retrieval of the geographical map data, and the commuter profiles.

For querying the database server 106, one or more querying languages, such as, but not limited to, SQL, QUEL, and DMX, may be utilized. In an embodiment, the database server 106 may connect to the application server 108, using one or more protocols, such as, but not limited to, the ODBC protocol and the JDBC protocol. In an embodiment, the database server 106 may be realized through various technologies such as, but not limited to, Microsoft® SQL Server, Oracle®, IBMDB2®, Microsoft Access®, PostgreSQL®, MySQL®, and SQLite®.

The application server 108 may refer to an electronic device, a computing device, or a software framework hosting an application or a software service that may be communicatively coupled to the communication network 118. In an embodiment, the application server 108 may be implemented to execute programs, routines, scripts, and/or the like, stored in one or more memory units for supporting the hosted application or the software service. In an embodiment, the hosted application or the software service may be configured to perform one or more predetermined operations for real time management of ridesharing services. In an embodiment, the application server 108 may be associated with a ridesharing service platform (not shown). The application server 108 may be configured to receive the first plurality of ridesharing requests, of the first plurality of commuters 104, from the first plurality of commuter-computing devices 102.

Each ridesharing request of the first plurality of ridesharing requests of the first plurality of commuters 104 may comprise a source location, a destination location, and a set of commuter constraints. In an embodiment, the set of commuter constraints may further include a waiting time threshold, a detour distance threshold, and/or a detour time threshold. The application server 108 may be further configured to match one of the first plurality of ridesharing requests with remaining of the first plurality of ridesharing requests based on the corresponding set of commuter constraints. For example, based on the set of commuter constraints the application server 108 may determine that one of the first plurality of ridesharing requests matches with three other ridesharing requests of the first plurality of ridesharing requests. After matching one of the first plurality of ridesharing requests with remaining of the first plurality of ridesharing requests, the application server 108 may be configured to identify a ridesharing vehicle, such as the first ridesharing vehicle 110A or the second ridesharing vehicle 110B, for serving the matched ridesharing requests. The application server 108 may be further configured to identify a route for the identified ridesharing vehicle to serve the matched ridesharing requests. For the identification of the route, the application server 108 retrieve the geographical map data from the database server 106. For example, the retrieved geographical map data may correspond to a multi-tier location data that may comprise a hierarchal discretization of a geographical region. The multi-tier location data may comprise three entities, such as a plurality of grids, a plurality of landmarks, and a plurality of clusters, into which the geographical region is divided.

In an embodiment, the application server 108 may be further configured to remove the matched ridesharing requests from the first plurality of ridesharing requests and may further perform the matching among the remaining first plurality of ridesharing requests. In other words, the application server 108 may be configured to perform the matching until one ridesharing vehicle, such as the first ridesharing vehicle 110A or the second ridesharing vehicle 110B, is identified for each ridesharing request of the first plurality of ridesharing requests. In an embodiment, the application server 108 may perform the matching among the first plurality of ridesharing requests for maximization (or optimization) of a key performance parameter as specified by a service provider of the plurality of ridesharing vehicles 110. The key performance parameter may correspond to a profit earned by the service provider of the plurality of ridesharing vehicles 110. The profit earned by the service provider may be determined based on a fare received from a plurality of commuters (such as the first plurality of commuters 104 or the second plurality of commuters 114) when a plurality of ridesharing requests of the plurality of commuters may be served and a wage factor of a driver associated with a ridesharing vehicle serving the plurality of ridesharing requests. In an embodiment, the service provider may specify another key performance parameter that may correspond to a number of driver-miles for serving the first plurality of ridesharing requests of the first plurality of commuters 104. In this scenario, the application server 108 may be configured to minimize the other key performance parameter.

In an embodiment, after the identification of the ridesharing vehicle for the matched ridesharing requests, the application server 108 may be further configured to determine an adaptive detour discount factor associated with the identified ridesharing vehicle based on the maximized (or minimized) key performance parameter. The application server 108 may use one or more algorithms, such as stochastic multi-armed bandit algorithm, known in the art for the determining of the adaptive detour discount factor.

In an embodiment, the application server 108 may further receive a second plurality of ridesharing requests of the second plurality of commuters 114 from the second plurality of commuter-computing devices 116. Thereafter, the application server 108 may be configured to match the second plurality of ridesharing requests among each other for the identification of ridesharing vehicles to serve each ridesharing request of the second plurality of ridesharing requests. The application server 108 may be configured to determine the profit earned by the service provider by use of the determined adaptive detour discount factor for serving the second plurality of ridesharing requests. Thus, the application server 108 may further update the maximized key performance parameter for the matched ridesharing requests in the second plurality of ridesharing requests based on the profit earned by serving the second plurality of ridesharing requests. In an embodiment, the application server 108 may further update the determined adaptive detour discount factor based on the updated maximized key performance parameter. In an embodiment, the application server 108 may be further configured to render the determined adaptive detour discount factor on a display-screen of the second plurality of commuter-computing devices 116 associated with the second plurality of commuters 114 through the interactive GUIs. In an embodiment, the application server 108 may be configured to dynamically update the determined adaptive detour discount factor based on new ridesharing requests received after the second plurality of ridesharing requests.

The application server 108 may be realized through various types of application servers, such as, but not limited to, a Java application server, a .NET framework application server, a Base4 application server, a PHP framework application server, or any other application server framework.

A person having ordinary skill in the art will appreciate that the scope of the disclosure is not limited to realizing the application server 108 and the database server 106 as separate entities. In an embodiment, the functionalities of the database server 106 can be integrated into the application server 108, without departing from the scope of the disclosure. Further, in an embodiment, the application server 108 may be realized as an application program installed and/or running on a vehicle-computing device, such as the first vehicle-computing device 112A or the second vehicle-computing device 112B, and/or the plurality of mobile computing devices, such as the first plurality of commuter-computing devices 102 or the second plurality of commuter-computing devices 116, without deviating from the scope of the disclosure.

Each ridesharing vehicle, such as the first ridesharing vehicle 110A or the second ridesharing vehicle 110B, in the plurality of ridesharing vehicles 110 may correspond to a transportation means utilized by any commuter to commute from a source location to a destination location. In an embodiment, each of the plurality of the ridesharing vehicles 110 may correspond to a variety of transportation services, such as, but not limited to, a bus, a car, a motorbike, or a cab. In an embodiment, each of the plurality of ridesharing vehicles 110 may be associated with a driver (not shown). For example, the first ridesharing vehicle 110A may be associated with the first driver and the second ridesharing vehicle 110B may be associated with the second driver. Further, the plurality of commuters, such as the first plurality of commuters 104 or the second plurality of commuters 114, may avail the plurality of ridesharing vehicles 110 to commute from a corresponding source location to a corresponding destination location. Further, each ridesharing vehicle in the plurality of ridesharing vehicles 110 may have a unique vehicle identification number. In an embodiment, each ridesharing vehicle in the plurality of ridesharing vehicles 110 may be associated with a vehicle-computing device. For example, the first ridesharing vehicle 110A may be associated with the first vehicle-computing device 112A and the second ridesharing vehicle 110B may be associated with the second vehicle-computing device 112B.

Each of the vehicle-computing devices, such as the first vehicle-computing device 112A or the second vehicle-computing device 112B, in the plurality of vehicle-computing devices 112 may refer to a computing device, installed in the corresponding ridesharing vehicle. For instance, the first vehicle-computing device 112A may be installed in the first ridesharing vehicle 110A and the second vehicle-computing device 112B may be installed in the second ridesharing vehicle 110B. The plurality of vehicle-computing devices 112 may be communicatively coupled to the communication network 118. Further, each vehicle-computing device in the plurality of vehicle-computing devices 112 may include one or more processors and one or more memory units. The one or more memory units may include a computer readable code that may be executable by the one or more processors to perform one or more operations as specified by the service provider of the plurality of vehicle-computing devices 112 and/or a driver of the corresponding ridesharing vehicle. In an embodiment, each of the plurality of vehicle-computing devices 112 may comprise a navigation device with inbuilt one or more positional sensors, such as GPS sensors. In an embodiment, the one or more positional sensors in each of the vehicle-computing devices may be configured to detect a current location of the corresponding ridesharing vehicle, while the corresponding ridesharing vehicle is in transit along a route associated with matched ridesharing requests that are to be served. Further, each vehicle-computing device in the plurality of vehicle-computing devices 112 may be configured to transmit information pertaining to the current location of the corresponding ridesharing vehicle to the application server 108, over the communication network 118. In an embodiment, each of the plurality of vehicle-computing devices 112 may be configured to present a navigational map to guide the driver of the corresponding ridesharing vehicle. The navigational map may further comprise the pick-up location and drop location of each commuter associated with the matched ridesharing requests for which the corresponding ridesharing vehicle is identified.

Each vehicle-computing device of the plurality of vehicle-computing devices 112 may correspond to a variety of computing devices, such as, but not limited to, a laptop, a PDA, a tablet computer, a smartphone, and a phablet.

Each commuter, such as the commuters 114A to 114C, in the second plurality of commuters 114 may refer to an individual who may raise a ridesharing request by using the corresponding commuter-computing device in the second plurality of commuter-computing devices 116. For instance, the commuter 114A may use the commuter-computing device 116A to raise the ridesharing request to commute from a source location to a destination location. In an embodiment, each commuter, such as the commuters 114A to 114C, in the second plurality of commuters 114 may create a commuter profile at the time of registration with a ridesharing service platform associated with the application server 108. In another embodiment, the commuter profile of each commuter, such as the commuters 114A to 114C, may be created when he/she raises the ridesharing request for the first time. The commuter profile of a commuter may comprise details, such as a set of commuter constraints, pertaining to the commuter. In an embodiment, the commuter profile of each commuter, such as the commuters 114A to 114C, may be stored in the database server 106. In an embodiment, after raising the ridesharing request each commuter in the first plurality of commuters 114 may wait at the corresponding source location for pick up by a ridesharing vehicle, such as the first ridesharing vehicle 110A or the second ridesharing vehicle 110B.

Each commuter-computing device, such as the commuter-computing devices 116A to 116C, of the second plurality of commuter-computing devices 116 may refer to a computing device that may be communicatively coupled to the communication network 118. Each commuter-computing device, such as the commuter-computing devices 116A to 116C, may comprise one or more processors and one or more memory units. The one or more memory units may include computer readable codes and instructions that may be executable by the one or more processors to perform one or more predetermined operations. In an embodiment, each commuter-computing device, such as the commuter-computing devices 116A to 116C, may be associated with a commuter in the second plurality of commuters 114. For instance, the commuter-computing device 116A of the second plurality of commuter-computing devices 116 may be associated with the commuter 114A of the second plurality of commuters 114. The commuter-computing device 116A of the second plurality of commuter-computing devices 116 may be associated with the commuter 1148 of the first plurality of commuters 104. Further, the commuter-computing device 116C of the second plurality of commuter-computing devices 116 may be associated with the commuter 114A of the second plurality of commuters 114. In an embodiment, each commuter-computing device, such as the commuter-computing devices 116A to 116C, may be used by the corresponding commuter to raise a ridesharing request. In other words, the second plurality of commuter-computing devices 116 may be used by the second plurality of commuters 114 to raise the second plurality of ridesharing requests. Further, each commuter-computing device, such as the commuter-computing devices 116A to 116C, may be configured to receive the notification from the application server 108, over the communication network 118, in response to the ridesharing request raised by the corresponding commuter. The notification may be rendered in form of an interactive graphical user-interface (GUI) on a display screen of each of the commuter-computing devices, such as commuter-computing devices 116A to 116C, in the second plurality of commuter-computing devices 116. An example of the interactive GUI rendered on a commuter-computing device is described later in FIG. 5.

Each commuter-computing device, such as the commuter-computing devices 116A to 116C, in the second plurality of commuter-computing devices 116 may correspond to a variety of computing devices, such as, but not limited to, a laptop, a PDA, a tablet computer, a smartphone, and a phablet.

The communication network 118 may correspond to a medium through which content and messages flow between various devices, such as plurality of commuter-computing devices (i.e., the first plurality of commuter-computing devices 102 or the second plurality of commuter-computing devices 116), the database server 106, the application server 108, and the plurality of vehicle-computing devices 112 of the system environment 100. Examples of the communication network 118 may include, but are not limited to, the Internet, a cloud network, a Wireless Fidelity (Wi-Fi) network, a Wireless Local Area Network (WLAN), a Local Area Network (LAN), a wireless personal area network (WPAN), a wireless wide area network (WWAN), a cloud network, a Long Term Evolution (LTE) network, a plain old telephone service (POTS), and/or a Metropolitan Area Network (MAN). Various devices in the system environment 100 can connect to the communication network 118 in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

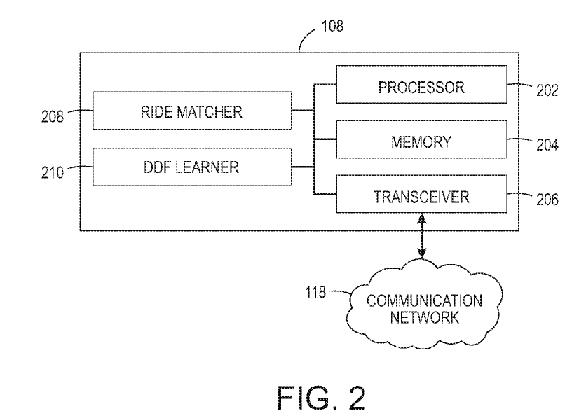

FIG. 2 is a block diagram that illustrates an application server, in accordance with at least one embodiment. FIG. 2 has been described in conjunction with FIG. 1. With reference to FIG. 2, there is shown a block diagram of the application server 108 that may include a processor 202, a memory 204, a transceiver 206, a ride matcher 208, and a detour discount factor (DDF) learner 210. The processor 202 is communicatively coupled to the memory 204, the transceiver 206, the ride matcher 208, and the DDF learner 210.

The processor 202 includes suitable logic, circuitry, and/or interfaces that are configured to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform one or more operations for real time management of ridesharing services. In an embodiment, the processor 202 may be configured to instruct the ride matcher 208 to perform the one or more operations for the real time management of ridesharing services. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store the one or more sets of instructions that are executable by the processor 202, the transceiver 206, the ride matcher 208, and the DDF learner 210. In an embodiment, the memory 204 may include one or more buffers (not shown). The one or more buffers may store one or more algorithms for the execution of the matching of the ridesharing requests and the determining of the adaptive detour distance factor. In an embodiment, the one or more buffers may further store a set of detour discount factors from which the determined detour discount factor is identified. Examples of some of the commonly known memory implementations may include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations for the real time management of ridesharing services. It will be apparent to a person having ordinary skill in the art that the one or more instructions stored in the memory 204 may enable the hardware of the application server 108 to perform the one or more predetermined operations, without deviating from the scope of the disclosure.

The transceiver 206 transmits/receives messages and data to/from various components, such as a plurality of commuter-computing devices (i.e., the first plurality of commuter-computing devices 102 or the second plurality of commuter-computing devices 116), the database server 106, and the plurality of vehicle-computing devices 112, of the system environment 100, over the communication network 118. In an embodiment, the transceiver 206 may be communicatively coupled to the communication network 118. The transceiver 206 may implement one or more known technologies to support wired or wireless communication with the communication network 118. In an embodiment, the transceiver 206 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a WLAN and/or a MAN. The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, and a protocol for email, instant messaging, and/or Short Message Service (SMS).

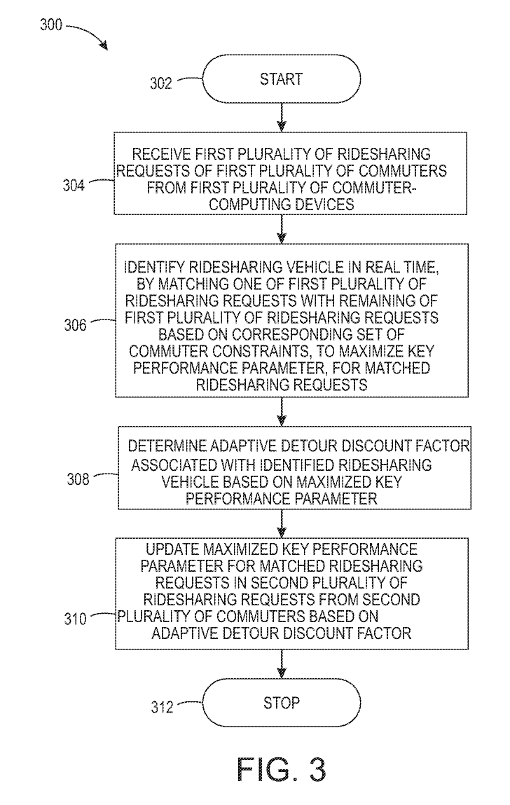

The ride matcher 208 includes suitable logic, circuitry, and/or interfaces that are configured to execute one or more instructions stored in the memory 204. In an embodiment, the ride matcher 208 may be configured to match a plurality of ridesharing requests among each other. For instance, the ride matcher 208 may be configured to match the first plurality of ridesharing requests among each other. In an embodiment, the ride matcher 208 may execute the matching of ridesharing requests based on the set of commuter constraints. In an embodiment, the ride matcher 208 may use one or more greedy algorithms (described later in FIG. 3) for the matching of the ridesharing requests. In an embodiment, the ride matcher 208 may be configured to identify a ridesharing vehicle, such as the first ridesharing vehicle 110A or the second ridesharing vehicle 110B, for the matched ridesharing requests. The ride matcher 208 may use a set of vehicle constraints specified by the service provider for the identification of the ridesharing vehicle, such as the first ridesharing vehicle 110A or the second ridesharing vehicle 110B, for the matched ridesharing requests. The set of vehicle constraints may include a capacity constraint of a ridesharing vehicle. Examples of the ride matcher 208 may include, but are not limited to, an X86-based processor, a RISC processor, an ASIC processor, a CISC processor, and/or other processor.

A person having ordinary skill in the art will appreciate that the scope of the disclosure is not limited to realizing the ride matcher 208 and the processor 202 as separate entities. In an embodiment, the functionalities of the ride matcher 208 may be implemented within the processor 202, without departing from the spirit of the disclosure. Further, a person skilled in the art will understand that the scope of the disclosure is not limited to realizing the ride matcher 208 as a hardware component. In an embodiment, the ride matcher 208 may be implemented as a software module included in computer program code (stored in the memory 204), which may be executable by the processor 202 to perform the functionalities of the ride matcher 208.

The DDF learner 210 includes suitable logic, circuitry, and/or interfaces that are configured to execute one or more instructions stored in the memory 204. In an embodiment, the DDF learner 210 may be configured to determine an adaptive detour discount factor from the set of detour discount factors based on the maximized key performance parameter. The DDF learner 210 may be further configured to update the determined adaptive detour discount factor based on any update in the maximized key performance parameter. The DDF learner 210 may use one or more algorithms, such as stochastic multi-armed bandit algorithm, stored in the memory 204 for the determining and update of the adaptive detour discount factor. Examples of the DDF learner 210 may include, but are not limited to, an X86-based processor, a RISC processor, an ASIC processor, a CISC processor, and/or other processor.

A person having ordinary skill in the art will appreciate that the scope of the disclosure is not limited to realizing the DDF learner 210 and the processor 202 as separate entities. In an embodiment, the functionalities of the DDF learner 210 may be implemented within the processor 202, without departing from the spirit of the disclosure. Further, a person skilled in the art will understand that the scope of the disclosure is not limited to realizing the DDF learner 210 as a hardware component. In an embodiment, the DDF learner 210 may be implemented as a software module included in computer program code (stored in the memory 204), which may be executable by the processor 202 to perform the functionalities of the DDF learner 210.

An embodiment of the working of the application server 108 for the real time management of ridesharing services has been explained later in FIG. 3.

FIG. 3 depicts a flowchart that illustrates a method for real time management of ridesharing services, in accordance with at least one embodiment. FIG. 3 is described in conjunction with FIG. 1 and FIG. 2. With reference to FIG. 3, there is shown a flowchart 300 that illustrates a method for real time management of ridesharing services. The method starts at step 302 and proceeds to step 304.

At step 304, the first plurality of ridesharing requests of the first plurality of commuters is received from the first plurality of computing devices. In an embodiment, the processor 202 may be configured to instruct the transceiver 206 to receive the first plurality of ridesharing requests of the first plurality of commuters 104 from the first plurality of commuter-computing devices 102.

In an embodiment, each of the first plurality of commuters 104 may raise the first plurality of ridesharing requests by use of the corresponding commuter-computing device in the first plurality of commuter-computing devices 102. Each ridesharing request in the first plurality of ridesharing requests may include a source location, a destination location, and a set of commuter constraints as specified by the corresponding commuter. For instance, a ridesharing request of the commuter 104A may include the source location, the destination location, and the set of commuter constraints as specified by the commuter 104A. The set of commuter constraints in each of the first plurality of ridesharing requests may include the waiting time threshold, the detour distance threshold, and/or the detour time threshold as specified by the corresponding commuter. For example, the commuter 104A may not be ready to wait for more than “15 minutes” for a pick up by a ridesharing vehicle. Further, the commuter 104A may be ready to travel a maximum detour of “1 km” or “20 minutes,” while traveling in the ridesharing vehicle to pick up or drop off any other co-commuter. In such a case, the commuter 104A may specify the waiting time threshold to be “15 minutes,” the detour distance threshold to be “1 km” and the detour time threshold to be “20 minutes.”

In an embodiment, the first plurality of commuters 104 may not specify the set of commuter constraints in the first plurality of ridesharing requests. In such a case, the processor 202 may be configured to retrieve the commuter profiles of each of the first plurality of commuters 104 from the database server 106. The commuter profiles of each of the first plurality of commuters may include the set of commuter constraints specified by each of the commuter at the time of registration with the ridesharing service platform. Thus, the processor 202 may extract the set of commuter constraint of each commuter in the first plurality of commuters 104 from the corresponding commuter profile.

In an embodiment, the processor 202 may not receive each ridesharing request in the first plurality of ridesharing requests at the same time instant. The processor 202 may receive the ridesharing requests in the first plurality of ridesharing requests at different time instants. For example, the processor may receive a ridesharing request from the commuter 104A at “10:00 a.m.,” another ridesharing request from the commuter 1048 at “10:01 a.m.,” and another ridesharing request from the commuter 104C at “10:02 a.m.” In this scenario, the processor 202 may be configured to define a time interval, such that the ridesharing requests received by the processor 202 during the defined time interval may be addressed simultaneously by the processor 202. For example, the processor 202 may define the time interval to be “15 minutes.” Thus, at the start of a day, such as at “7:00 a.m.,” the ridesharing requests that are received between “7:00 a.m.” and “7:15 a.m.” may be considered as the first plurality of ridesharing requests to be addressed simultaneously. Further, the ridesharing requests received by the processor 202 between “7:15 a.m.” and “7:30 a.m.” may be considered as another first plurality of ridesharing requests to be addressed simultaneously.

A person having ordinary skill in the art will understand that the abovementioned example is for illustrative purpose and should not be construed to limit the scope of disclosure.

At step 306, a ridesharing vehicle is identified in real time, by matching one of the first plurality of ridesharing requests with remaining of the first plurality of ridesharing requests to maximize the key performance parameter for the matched ridesharing requests. The matching of one of the first plurality of ridesharing requests with remaining of the first plurality of ridesharing requests is based on the corresponding set of commuter constraints. In an embodiment, the processor 202 may be configured to instruct the ride matcher 208 to identify a ridesharing vehicle in real time, by matching one of the first plurality of ridesharing requests with remaining of the first plurality of ridesharing requests to maximize the key performance parameter for the matched ridesharing requests. In an embodiment, the matching one of the first plurality of ridesharing requests with remaining of the first plurality of ridesharing requests may minimize the other key performance parameter (i.e., a number of driver-miles for serving the first plurality of commuters 104) specified by the service provider. A person having ordinary skill in the art will appreciate that the usage of words, such as minimize, maximize, optimize, and/or any other similar words, in the disclosure are to be construed broadly within the ongoing practical context, and should not be construed as yielding a provable mathematical maximum or optimum solution

The ride matcher 208 may execute the matching of one of the first plurality of ridesharing requests with remaining of the first plurality of ridesharing requests based on the corresponding set of commuter constraints. In an embodiment, the ride matcher 208 may be configured to perform the matching of the ridesharing requests for every defined time interval. For instance, for a defined time interval of “15 minutes,” the ride matcher 208 may perform the matching of the ridesharing requests after every “15 minutes.” For example, the ride matcher 208 may perform the matching of the ridesharing requests at “7:00 a.m.” Thus, the ride matcher 208 may again perform the matching of the ridesharing requests at “7:15 a.m.”

A person having ordinary skill in the art will understand that the abovementioned example is for illustrative purpose and should not be construed to limit the scope of the disclosure. Further, in an embodiment, the processor 202 may define the time interval to perform matching based on an average count of ridesharing requests received and an average waiting time threshold.

In an embodiment, the ride matcher 208 may perform the matching among the first plurality of ridesharing requests based on a matching constraint. The matching constraint ensures that each ridesharing request in the first plurality of ridesharing requests is to be served no later than a time aᵢ+tᵢ, where aᵢ represents a time instant at which a ridesharing request i is received by the processor 202 and tᵢ represents a waiting time threshold as specified by a commuter associated with the ridesharing request i. Further, the ride matcher 208 may ensure that the waiting time threshold tᵢ is greater than an expected time duration for pick-up of the commuter associated with the ridesharing request i by an identified ridesharing vehicle, such as the first ridesharing vehicle 110A or the second ridesharing vehicle 110B. In an embodiment, when the waiting time threshold tᵢ of the commuter associated with the ridesharing request i is greater than the defined time interval, the ridesharing request i may be addressed by the ride matcher 208 for the next defined time interval. For example, the commuter 104A may raise a ridesharing request at “7:00 a.m.” with a waiting time threshold tᵢ=“25 minutes.” The ride matcher 208 may perform the matching at “7:00 a.m.” In a scenario, when no other ridesharing request is a match for the ridesharing request of the commuter 104A, the ride matcher 208 may match the ridesharing request of the commuter 104A in the next defined time interval (i.e., at “7:16 a.m.”) as the waiting time threshold tᵢ (i.e., “25 minutes”) specified by the commuter 104A is greater than the defined time interval (i.e., “15 minutes”). In another scenario, the commuter 104A may specify a waiting time threshold tᵢ, =“10 minutes.” In such a case, the ride matcher 208 may address the ridesharing request of the commuter 104A in the current defined time interval in which the ridesharing request is received.

A person having ordinary skill in the art will understand that abovementioned exemplary scenario is for illustrative purpose and should not be construed to limit the scope of the disclosure.

In an embodiment, the ride matcher 208 may perform matching among the first plurality of ridesharing requests by use of one or more greedy algorithms. In an exemplary greedy algorithm, for “n” ridesharing requests in the first plurality of ridesharing requests of the first plurality of commuters 104, the ride matcher 208 may be configured to identify a maximum of “n” ridesharing vehicles, such as the ridesharing vehicles 110A to 1108 in the plurality of ridesharing vehicles 110.

Prior to the identification of the ridesharing vehicles, the ride matcher 208 may be configured to assign one ridesharing request to one ridesharing vehicle. For example, the ride matcher 208 may assign the ridesharing request of the commuter 104A to the first ridesharing vehicle 110A. Similarly, the ridesharing request of the commuter 104B may be assigned to the second ridesharing vehicle 110B and the ridesharing request of the commuter 104C may be assigned to a third ridesharing vehicle (not shown).

Thereafter, the ride matcher 208 may be configured to create a first list of the first plurality of ridesharing requests. The ride matcher 208 may create the first list based on a distance to be traveled by the ridesharing vehicle assigned to each ridesharing request for serving the corresponding ridesharing request of the first plurality of ridesharing requests. For instance, the ride matcher 208 may arrange the ridesharing requests in the first list based on a decreasing order of the distance to be traveled by the corresponding ridesharing vehicle. For example, the first ridesharing vehicle 110A may have to travel a distance of “4 km” for serving the ridesharing request of the commuter 104A, the second ridesharing vehicle 110B may have to travel a distance of “3.6 km” for serving the ridesharing request of the commuter 104B, and the third ridesharing vehicle may have to travel a distance of “4.7 km” for serving the ridesharing request of the commuter 104C. Thus, the ride matcher 208 may create the first list illustrated in Table 1, as shown below:

TABLE 1
First list of ridesharing requests

| Ridesharing request by | Ridesharing vehicle | Distance to be traveled | |
|---|---|---|---|
| Commuter 104C | Third ridesharing | 4.7 | km |
| | vehicle | | |
| Commuter 104A | First ridesharing vehicle | 4 | km |
| | 110A | | |
| Commuter 104B | Second ridesharing | 3.6 | km |
| | vehicle 110B | | |

After creating the first list, the ride matcher 208 may be configured to remove the first entry (i.e., the first row) of the first list (i.e., the ridesharing request of commuter 104C assigned to the third ridesharing vehicle). Thereafter, the ride matcher 208 may be configured to match the removed entry with the remaining entries of the first list based on the set of commuter constraints of the ridesharing request in the removed entry and the remaining entries of the first list. In other words, the ride matcher 208 may be configured to match one of the first plurality of ridesharing requests with remaining of the first plurality of ridesharing requests based on the corresponding set of commuter constraints. For matching the removed entry with the remaining entries of the first list, the ride matcher 208 may be configured to traverse the first list from top to bottom. The ride matcher 208 may perform matching of the remaining entries of the first list with the removed entry based on the corresponding set of commuter constraints, a set of vehicle constraints, and an increment in value of a profitability parameter. The set of vehicle constraints may include the capacity constraint of the ridesharing vehicle in the removed entry of the first list. In an embodiment, the ride matcher 208 may determine the profit parameter associated with a ridesharing vehicle based on equations (1) to (3), as shown below:

Cᵢ(S)=(1−fₚ(δᵢ(S),τᵢ(S)))·(c_{b}+c_{d}dᵢ({i})+cₜtᵢ({i})) (1)

where,

i represents a ridesharing request in the first plurality of ridesharing requests (S);

dᵢ({i}) represents a distance (i.e., between a source location and a destination location) to be traveled by a ridesharing vehicle for serving a ridesharing request i;

tᵢ({i}) represents time (i.e., between a source location and a destination location) of travel in which the ridesharing vehicle travels distance dᵢ({i}) for serving the ridesharing request i;

fₚ(δᵢ(S), τᵢ (S)) represents an adaptive detour discount factor which is a function of detour distance δᵢ(S) and detour time τᵢ(S) associated with the ridesharing request i;

c_{b} represents a fixed base fare specified by the service provider of the plurality of ridesharing vehicles 110;

c_{d} represents a cost per unit distance, as specified by the service provider, to be charged to a commuter for availing a ridesharing vehicle to travel;

cₜ represents a cost per unit time, as specified by the service provider, to be charged to a commuter for availing the ridesharing vehicle to travel; and

Cᵢ(S) represents a total fare a commuter associated with the ridesharing request i is to be charged for availing the ridesharing vehicle to travel.

E(S)=(1−f_{d})·(c_{b}+c_{d}d(S)+cₜt(S)) (2)

where,

d(S) represents a distance traveled by an identified ridesharing vehicle for serving a plurality of ridesharing requests (S) (such as the first plurality of ridesharing requests);

t(S) represents time of travel in which the ridesharing vehicle travels the distance d(S) for serving the plurality of ridesharing requests (S) (such as the first plurality of ridesharing requests);

f_{d} represents a driver earning parameter as specified by the service provider of the plurality of ridesharing vehicles (such as the plurality of ridesharing vehicles 110); and

E(S) represents earning of the driver of the ridesharing vehicle for serving the plurality of ridesharing requests (S) (such as the first plurality of ridesharing requests).

p(S)=Σ_{i∈S}Cᵢ(S)−E(S) (3)

where,

Σ_{i∈S} Cᵢ(S) represents total fare to be collected from a plurality of commuters associated with the plurality of ridesharing requests (i∈S) for availing the ridesharing vehicle to travel; and

p(S) represents the profit parameter associated with the ridesharing vehicle for serving the plurality of ridesharing requests (i∈S) (such as the first plurality of ridesharing requests).

Thereafter, the ride matcher 208 may be further configured to determine the increment in the value of the profitability parameter due to matching of the removed entry of the first list with any of the remaining entries of the first list. For example, the ride matcher 208 may use equation (4), as shown below, for the determination of the increment in the value of the profitability parameter:

Δp(Sⱼ,Sₖ)=p(Sⱼ∪Sₖ)−p(Sⱼ)−p(Sₖ) (4)

where,

p(Sⱼ) represents the profitability parameter associated with the ridesharing vehicle for serving a j^{th} ridesharing request of the plurality of ridesharing requests (such that j∈S);

p(Sₖ) represents the profitability parameter associated with the ridesharing vehicle for serving a k^{th} ridesharing request of the plurality of ridesharing requests (such that j∈S);

p(Sⱼ∪Sₖ) represents the profitability parameter associated with the ridesharing vehicle for serving both the j^{th} ridesharing request and the k^{th} ridesharing request of the plurality of ridesharing requests (such that j, k∈S); and

Δp(Sⱼ, Sₖ) represents the increment in the value of the profitability parameter for the ridesharing vehicle by serving both the j^{th} ridesharing request and the k^{th} ridesharing request of the plurality of ridesharing requests (such that j, k∈S).

In an embodiment, based on the matching, the ride matcher 208 may be configured to merge the ridesharing requests. In an exemplary scenario, while traversing down the first list, the ride matcher 208 may perform a matching between the removed entry of the first list (i.e., the ridesharing request of commuter 104C assigned to the other ridesharing vehicle) and the first entry (i.e., the ridesharing request of commuter 104A assigned to the first ridesharing vehicle 110A) in the remaining entries of the first list based on the corresponding set of commuter constraints, the set of vehicle constraints, and the increment in value of the profitability parameter. The ride matcher 208 may determine that the set of vehicle constraints (i.e., the capacity constraint of the other ridesharing vehicle) is not violated on matching the removed entry with the first entry in the remaining entries of the first list. In other words, the third ridesharing vehicle may have a capacity to accommodate the commuter 104A along with the commuter 104C. Further, the ride matcher 208 may determine that the set of commuter constraints is not violated on matching the removed entry with the first entry in the remaining entries of the first list. In other words, if the third ridesharing vehicle may be assigned to pick the commuter 104C along with the commuter 104A, the waiting time threshold, the detour distance threshold, and the detour time threshold, of both the commuters (i.e., the commuter 104C and the commuter 104A) are satisfied. However, the ride matcher 208 may determine that the increment in the value of the profitability parameter for the third ridesharing vehicle by serving the ridesharing requests of both the commuters (i.e., the commuter 104C and the commuter 104A) is a negative value. In such a case, the ride matcher 208 may not merge the removed entry of the first list (i.e., the ridesharing request of commuter 104C assigned to the other ridesharing vehicle) with the first entry (i.e., the ridesharing request of commuter 104A assigned to the first ridesharing vehicle 110A) in the remaining entries of the first list.

Thereafter, the ride matcher 208 may perform a matching between the removed entry of the first list (i.e., the ridesharing request of commuter 104C assigned to the other ridesharing vehicle) and the second entry (i.e., the ridesharing request of commuter 104B assigned to the second ridesharing vehicle 110B) in the remaining entries of the first list based on the corresponding set of commuter constraints, the set of vehicle constraints, and the increment in value of the profitability parameter. The ride matcher 208 may further determine that the set of vehicle constraints (i.e., the capacity constraint of the other ridesharing vehicle) is not violated on matching the removed entry with the second entry in the remaining entries of the first list. In other words, the third ridesharing vehicle may have a capacity to accommodate the commuter 104B along with the commuter 104C. Further, the ride matcher 208 may determine that the set of commuter constraints is not violated on matching the removed entry with the second entry in the remaining entries of the first list. In other words, if the third ridesharing vehicle may be assigned to pick the commuter 104C along with the commuter 104B, the waiting time threshold, the detour distance threshold, and the detour time threshold, of both the commuters (i.e., the commuter 104C and the commuter 104B) are satisfied. The ride matcher 208 may further determine that the increment in the value of the profitability parameter for the third ridesharing vehicle by serving the ridesharing requests of both the commuters (i.e., the commuter 104C and the commuter 104B) is a positive value. In such a case, the ride matcher 208 may merge the removed entry of the first list (i.e., the ridesharing request of commuter 104C assigned to the other ridesharing vehicle) with the second entry (i.e., the ridesharing request of commuter 104B assigned to the second ridesharing vehicle 110B) in the remaining entries of the first list. In other words, based on matching of the ridesharing requests, the ride matcher 208 may assign the third ridesharing vehicle to both the ridesharing requests of the commuter 104C and the commuter 104B.

A person having ordinary skill in the art will understand that the abovementioned exemplary scenario is for illustrative purpose and should not be construed to li it the scope of the disclosure.

In an embodiment, the ride matcher 208 may be further configured to remove the entry which is merged with the previously removed entry. For example, with reference to Table 1, the ride matcher 208 may remove the third entry (i.e., the ridesharing request of commuter 104B assigned to the second ridesharing vehicle 110B) which is merged with the first entry (i.e., the ridesharing request of commuter 104C assigned to the other ridesharing vehicle) of the first list. The ride matcher 208 may be further configured to determine a distance to be traveled by the third ridesharing vehicle for serving the merged ridesharing requests (i.e., the ridesharing request of commuter 104C and the ridesharing request of commuter 104B). For example, the ride matcher 208 may determine that the distance to be traveled by the third ridesharing vehicle for serving the merged ridesharing requests is “5.8 km.” The ride matcher 208 may further update the first list based on an insertion of the merged ridesharing requests at an appropriate location in the first list in accordance with the distance to be traveled by the third ridesharing vehicle for serving the merged ridesharing requests. Table 2, as shown below, illustrates the updated first list after the insertion of the merged ridesharing requests:

TABLE 2
Updated first list of ridesharing requests

| Ridesharing request by | Ridesharing vehicle | Distance to be traveled | |
|---|---|---|---|
| Commuter 104C and | Third ridesharing | 5.8 | km |
| Commuter 104B | vehicle | | |
| Commuter 104A | First ridesharing | 4 | km |
| | vehicle 110A | | |

The ride matcher 208 may be further configured to iteratively perform the matching of the ridesharing requests with respect to the updated first list. In a scenario, the ride matcher 208 may determine that the removed entry of the first list (or the updated first list) is not a match for the remaining entries of the first list (or the updated first list). In such a case, the ride matcher 208 may populate a second list, which may be empty initially, with the removed entry of the first list. With reference to Table 2, the ride matcher 208 may determine the first entry in the updated list is not a match for the remaining entries in the updated first list. Thus, the ride matcher 208 may populate the second list with the first entry of the updated list (i.e., the ridesharing request of commuter 104C and the ridesharing request of commuter 104B to be served by third ridesharing vehicle). For example, Table 3, as shown below, illustrates the second list created after the matching of the ridesharing requests is complete:

TABLE 3
Second list of merged ridesharing requests

| Ridesharing request by | Ridesharing vehicle |
|---|---|
| Commuter 104C and | Third ridesharing vehicle |
| Commuter 104B | |
| Commuter 104A | First ridesharing vehicle 110A |

With reference to Table 3, the two entries (i.e., two rows) represent final merged ridesharing requests based on the matching performed by the ride matcher 208. Thereafter, the ride matcher 208 may utilize the second list to identify a ridesharing vehicle for the merged ridesharing requests of the first plurality of ridesharing requests in real time. For example, with reference to the second list of merged ridesharing requests (illustrated in Table 3), the ride matcher 208 may identify the third ridesharing vehicle for the ridesharing requests by the commuter 104B and the commuter 104C and the first ridesharing vehicle 110A for the ridesharing request by the commuter 104A. The first ridesharing vehicle 110A identified for the ridesharing request by the commuter 104A may correspond to a vehicle dedicated only to the commuter 104A. In an embodiment, the ride matcher 208 may be further configured to match another real time ridesharing request with the ridesharing request by the commuter 104A, while the commuter 104A may be traveling in the first ridesharing vehicle 110A.

A person having ordinary skill in the art will understand that the abovementioned exemplary scenario is for illustrative purpose and should not be construed to limit the scope of the disclosure.

In another exemplary greedy algorithm, the ride matcher 208 may be configured to create the first list of the first plurality of ridesharing requests based on the profitability parameter associated (i.e., determined based on equations (1) to (3)) with the ridesharing vehicle assigned to each ridesharing request for serving the corresponding ridesharing request. For instance, the ride matcher 208 may arrange the ridesharing requests in the first list based on an increasing order of the profitability parameter associated with the ridesharing vehicle assigned to each ridesharing request of the first plurality of ridesharing requests. Further, the ride matcher 208 may perform the matching and update of the first list as described previously to create the second list of merged ridesharing requests.

In another exemplary greedy algorithm, the ride matcher 208 may further identify a ridesharing vehicle for the matched ridesharing requests of the first plurality of ridesharing based on an increment in the value of the profitability parameter associated with the ridesharing vehicle. Prior to the identification of the ridesharing vehicles, the ride matcher 208 may be configured to assign one ridesharing request to one ridesharing vehicle. For example, the ride matcher 208 may assign the ridesharing request of the commuter 104A to the first ridesharing vehicle 110A. Similarly, the ridesharing request of the commuter 104B may be assigned to the second ridesharing vehicle 110B and the ridesharing request of the commuter 104C may be assigned to the third ridesharing vehicle. For “n” ridesharing requests in the first plurality of ridesharing requests of the first plurality of commuters 104, the ride matcher 208 may be configured to iteratively perform the following two steps to identify a maximum of “n” ridesharing vehicles.

### Step 1:

The ride matcher 208 may be configured to determine the profitability parameter for each assigned ridesharing vehicle by use of equations (1) to (3). Further, the ride matcher 208 may be configured to determine the increment in the value of the profitability parameter by use of equation (4) for all possible pairs of the assigned ridesharing vehicles that meet the set of vehicle constraints and the set of commuter constraints. In other words, for every two assigned ridesharing vehicles (such as j^{th} ridesharing vehicle and k^{th} ridesharing vehicle) that meet the set of vehicle constraints and the set of commuter constraints, the ride matcher 208 may determine the increment in the value of the profitability parameter by use of equation (4). For example, the ride matcher 208 may assign “five” ridesharing vehicles, such as “V1,” “V2,” “V3,” “V4,” and “V5,” to “five” ridesharing requests, such as “R1,” “R2,” “R3,” “R4,” and “R5,” respectively. In a scenario, when all the pairs of the ridesharing vehicles meet the set of vehicle constraints and the set of commuter constraints, the possible pairs of the assigned ridesharing vehicles may be [(“V1,” “V2”), (“V1,” “V3”), (“V1,” “V4”), (“V1,” “V5”), (“V2,” “V3”), (“V2”, “V4”), (“V2”, “V5”), (“V3”, “V4”), (“V3”, “V5”), and (“V4” “V5”)]. Thus, the ride matcher 208 may be configured to determine the increment in the value of the profitability parameter for all the possible pairs (i.e., [(“V1,” “V2”), (“V1,” “V3”), (“V1,” “V4”), (“V1,” “V5”), (“V2,” “V3”), (“V2”, “V4”), (“V2”, “V5”), (“V3”, “V4”), (“V3”, “V5”), and (“V4” “V5”)]) of the assigned ridesharing vehicles.

### Step 2:

The ride matcher 208 may be configured to identify a pair of the assigned ridesharing vehicles in the possible pairs (i.e., [(“V1,” “V2”), (“V1,” “V3”), (“V1,” “V4”), (“V1,” “V5”), (“V2,” “V3”), (“V2”, “V4”), (“V2”, “V5”), (“V3”, “V4”), (“V3”, “V5”), and (“V4” “V5”)]) of the assigned ridesharing vehicles that has a maximum increment in the value of the profitability parameter. For example, the ride matcher 208 may determine that the pair (“V1” and “V2”) has the maximum increment in the value of the profitability parameter. The ride matcher 208 may be further configured to determine whether the maximum increment in the value of the profitability parameter corresponds to a positive value or a negative value. In a scenario, the ride matcher 208 may determine that the maximum increment in the value of the profitability parameter corresponds to a negative value. In such a case, the assigned ridesharing vehicles may correspond to the identified ridesharing vehicles for the corresponding ridesharing requests. In another scenario, the ride matcher 208 may determine that the maximum increment in the value of the profitability parameter corresponds to a positive value. In such a case, the ride matcher 208 may assign a merged ridesharing vehicle that may serve the ridesharing requests associated with the pair that has maximum increment in the value of the profitability parameter. In an exemplary scenario, the ride matcher 208 may assign a merged ridesharing vehicle to the ridesharing requests “R1” and “R2” that are associated with the pair (“V1” and “V2”) of the assigned ridesharing vehicles that has the maximum increment in the value of the profitability parameter.

In an embodiment, the ride matcher 208 may be configured to perform the abovementioned steps iteratively until no pair of the assigned ridesharing vehicles has a maximum increment in the value of the profitability parameter that corresponds to a positive value. For example, Table 4, as shown below, illustrates the merged ridesharing vehicles corresponding to the ridesharing requests after the completion of the iterations of the abovementioned steps:

TABLE 4
Merged ridesharing vehicles corresponding
to the ridesharing requests

| Merged ridesharing requests | Merged ridesharing vehicles |
|---|---|
| R1 and R2 | V1 |
| R3, R4, and R5 | V3 |

With reference to Table 4, the ride matcher 208 may be configured to identify the ridesharing vehicle “V1” for the ridesharing requests “R1” and “R2” and the ridesharing vehicle “V3” for the ridesharing requests “R3,” “R4,” and “R5.”

A person having ordinary skill in the art will understand that the abovementioned Table is for illustrative purpose and should not be construed to limit the scope of the disclosure.

In an embodiment, the ride matcher 208 may be further configured to transmit another notification to the vehicle-computing devices of the identified ridesharing vehicles. The other notification may include a route to be followed for the pick-up and drop of commuters associated with the ridesharing requests for which the corresponding ridesharing vehicle is identified. For example, with reference to Table 4, the other notification transmitted to a vehicle-computing device installed in the ridesharing vehicle “V3” may include a route to be followed for the pick-up and drop of commuters associated with the ridesharing requests “R3,” “R4,” and “R5” for which the ridesharing vehicle “V3” is identified.

At step 308, an adaptive detour discount factor associated with the identified ridesharing vehicle is determined based on the maximized key performance parameter. In an embodiment, the DDF learner 210 may be configured to determine the adaptive detour discount factor associated with the identified ridesharing vehicle based on the maximized key performance parameter. In an embodiment, the determination of the adaptive detour discount factor may correspond to a learning by the DDF learner 210. The DDF learner 210 may use one or more algorithms, such as stochastic multi-armed bandit algorithm, known in the art for the determining of the adaptive detour discount factor.

In an embodiment, the DDF learner 210 may be configured to determine the adaptive detour discount factor based on the first plurality of ridesharing requests. For example, the DDF learner 210 may fix an adaptive detour discount factor from a plurality of adaptive detour discount factors for serving the first plurality of ridesharing requests for a first time period, such as “one hour,” “one day,” or “one month.” In other words, the first plurality of commuters 104 associated with the first plurality of ridesharing requests may be charged based on the adaptive detour discount factor for availing a ridesharing vehicle to travel. Thus, the total fare to be charged to a commuter associated with the ridesharing request of the first plurality of ridesharing requests may be determined based on the fixed value of the adaptive detour discount factor for the first time period by use of equation (1). After the completion of the first time period, the DDF learner 210 may fix another adaptive detour discount factor from the plurality of adaptive detour discount factors for serving the first plurality of ridesharing requests for the next first time period. In other words, the DDF learner 210 may be configured to fix each of the plurality of adaptive detour discount factors for the first time period. In an exemplary scenario, the first time period may correspond to “one day.” Thus, the DDF learner 210 may fix each of the plurality of adaptive detour discount factors for a duration of “one day.”

In an embodiment, the DDF learner 210, in conjunction with the ride matcher 208, may be further configured to determine the profit earned by the service provider (i.e., the profitability parameter) for the first time period corresponding to each of the plurality of adaptive detour discount factors. For example, the plurality of adaptive detour discount factors as specified by the service provider may be [0.1, 0.3, 0.5, 0.6, 0.7, and 0.9]. Further, the DDF learner 210 may determine that for an adaptive detour discount factor, such as “0.1” fixed for one day (i.e., the first time period), the profit earned by the service provider is “USD 50.” Similarly, for the remaining adaptive detour discount factors in the plurality of adaptive detour discount factors each fixed for one day, the profit earned by the service provider is [“USD 55,” “USD 60,” “USD 54,” “USD 45,” and “USD 40”].

A person having ordinary skill in the art will understand that the abovementioned example is for illustrative purpose and should not be construed to limit the scope of the disclosure.

Thereafter, the DDF learner 210 may be configured to determine the adaptive detour discount factor associated with the identified ridesharing vehicles based on the maximized key performance parameter (i.e., the profit earned (or the profitability parameter) by the service provider). The DDF learner 210 may use equation (5) as shown below for determining the adaptive detour discount factor:

$${h}^{*} = {argmax}_{h} ( {p}_{h} + \sqrt{2 ln \vert φ \vert} ) \qquad ( 5 )$$

where,

ϕ represents an array that includes the plurality of adaptive detour discount factors (i.e., θ₁, θ₂, . . . , θₙ);

|ϕ| represents a count of elements (i.e., the plurality of adaptive detour discount factors) in the array ϕ;

pₕ represents the profit earned by the service provider for the first time period corresponding to the h^{th} element of the array ϕ; and

h* represents an element of the array ϕ for which the profit earned by the service provider for the first time period is maximum.

The DDF learner 210 may use the equation (5) to determine that for the adaptive detour discount factor (i.e., “0.5”) which is the 3^{rd} element of the array ϕ=[0.1, 0.3, 0.5, 0.6, 0.7, and 0.9], the profit (i.e., “USD 60”) earned by the service provider for the first time period is maximum. Thus, the adaptive detour discount factor (i.e., “0.5”) may correspond to the determined adaptive detour discount factor.

A person having ordinary skill in the art will understand that the abovementioned exemplary scenario is for illustrative purpose and should not be construed to limit the scope of the disclosure.

At step 310, the maximized key performance parameter, for the matched ridesharing requests in the second plurality of ridesharing requests from the second plurality of commuters, is updated. The update of the maximized key performance parameter is based on the determined adaptive detour discount factor. In an embodiment, the DDF learner 210 may be configured to update the maximized key performance parameter for the matched ridesharing requests in the second plurality of ridesharing requests from the second plurality of commuters 114. The DDF learner 210 may update the maximized key performance parameter based on the determined adaptive detour discount factor.

Prior to the update of the maximized key performance parameter, the processor 202 may be configured to receive the second plurality of ridesharing requests of the second plurality of commuters 114. The second plurality of ridesharing requests may refer to the ridesharing requests that may be received after the determining of the adaptive detour discount factor by the DDF learner 210. The ride matcher 208 may be configured to identify the ridesharing vehicle by matching one of the second plurality of ridesharing requests with remaining of the second plurality of ridesharing requests as identified for the first plurality of ridesharing requests. The ride matcher 208 may be further configured to render the determined adaptive detour discount factor on a display-screen of the second plurality of commuter-computing devices 116 associated with the second plurality of commuters 114. In an embodiment, a commuter in the second plurality of commuters 114 may perform a selection or rejection of a corresponding identified ridesharing vehicle based on the rendered adaptive detour discount factor. Thus, a likelihood of the selection of the corresponding identified ridesharing vehicle by the second plurality of commuters 114 may be influenced based on the adaptive detour discount factor rendered on the display-screen of the second plurality of commuter-computing devices 116.

An example for rendering the determined adaptive detour discount factor on a display-screen of a commuter-computing device in form of an interactive graphical user-interface (GUI) is described later in FIG. 5.

The ride matcher 208 may use the determined adaptive detour discount factor for determining the profit earned by the service provider, by serving the second plurality of ridesharing requests, by use of equations (1) to (3). Thereafter, the DDF learner 210 may be further configured to update the maximized key performance parameter based on the determined profit. For example, the DDF learner 210 determines that by use of the determined adaptive detour discount factor (i.e., “0.5”) for a second time period, the profit earned by the service provider is “USD 35.” Thus, the DDF learner 210 may update the maximized key performance parameter (i.e., the profit earned based on the determined adaptive detour discount factor for the second time period) based on the equation (6), as shown below:

pₕ*=pₕ*+p (6)

where,

p represents the profit earned by the service provider based on the determined adaptive detour discount factor for the second time period; and

pₕ* represents the updated maximized key performance parameter (i.e., the profit earned by the service provider) determined based on the determined adaptive detour discount factor for the first time period and the second time period.

For example, the updated maximized key performance parameter (i.e., the profit earned by the service provider) corresponding to the determined adaptive detour discount factor for the first time period and the second time period may correspond to a sum of the profit earned by the service provider by use of the adaptive detour discount factor for the first time period and the profit earned by the service provider by use of the determined adaptive detour discount factor for the second time period (i.e., pₕ*=USD 60+USD 35=USD 95).

In an embodiment, the DDF learner 210 may be further configured to update the determined adaptive detour discount factor based on the updated maximized key performance parameter (i.e., the profit earned by the service provider) by use of equation (7), as shown below:

$${h}^{*} = {argmax}_{h} ( \frac{{p}_{{h}^{*}}}{{k}_{{h}^{*}}} + \sqrt{\frac{2 ln t}{{k}_{{h}^{*}}}} ) \qquad ( 7 )$$

where,

t represents a count of times the value of adaptive detour discount factor is updated (and/or fixed). Thus, the value of t is incremented by “one” every time when the value of adaptive detour discount factor is updated (and/or fixed);

kₕ* represents the time period for which the determined adaptive discount was used. For example, the determined adaptive detour discount factor (i.e., 0.5) is used for a time period that's is a sum of the first time period and the second time period; and

h* represents the updated element of the array ϕ for which the updated key performance parameter (i.e., profit earned by the service provider) is maximized for the second time period.

In an embodiment, the DDF learner 210 may be configured to use the updated adaptive detour discount factor for other second plurality of ridesharing requests. Thus, the DDF learner 210 and the ride matcher 208 may iteratively perform the step 310 for the other second plurality of ridesharing requests. The ride matcher 208 may then render the updated adaptive detour discount factor on a display-screen of commuter-computing devices associated with the other second plurality of ridesharing requests. Control passes to end step 312.

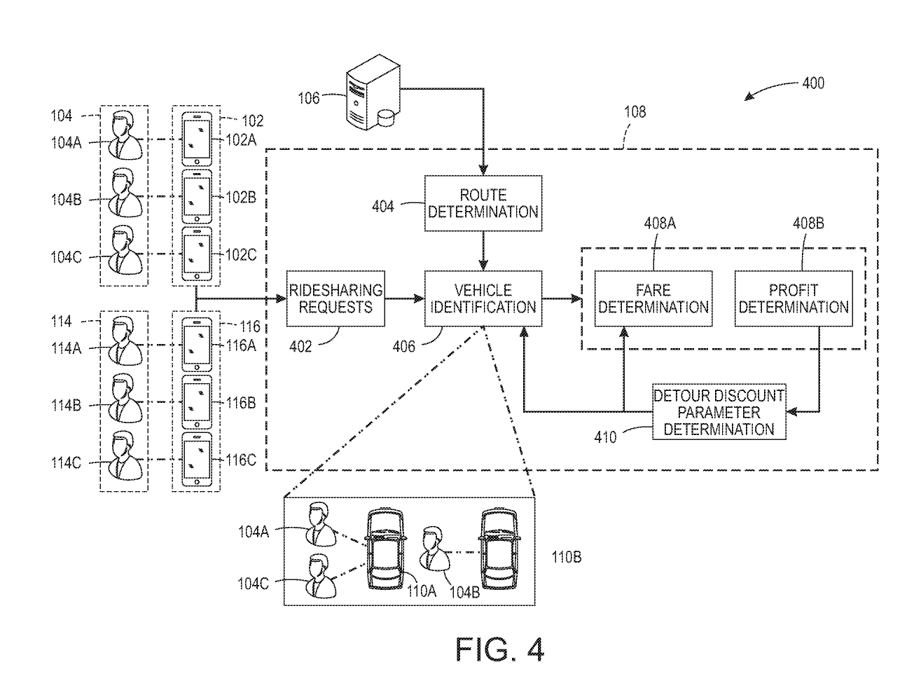

FIG. 4 is a block diagram that illustrates an exemplary scenario for real time management of ridesharing services, in accordance with at least one embodiment. FIG. 4 is described in conjunction with FIGS. 1-3. With reference to FIG. 4, there is shown an exemplary scenario 400 that includes the first plurality of commuters 104 associated with the first plurality of commuter-computing devices 102, the second plurality of commuters 114 associated with the second plurality of commuter-computing devices 116 and ridesharing requests 402. The exemplary scenario 400 further includes steps of route determination 404, vehicle identification 406, fare determination 408A, profit determination 408B, and detour discount parameter determination 410. The exemplary scenario 400 further includes the first ridesharing vehicle 110A, the second ridesharing vehicle 110B, and the database server 106.

The application server 108 may receive the ridesharing requests 402 of the first plurality of commuters 104 from the first plurality of commuter-computing devices 102. Each of the first plurality of commuters 104 may have specified the corresponding source location, the corresponding destination location, and the corresponding set of commuter constraints in the corresponding ridesharing request of the ridesharing requests 402. The application server 108 may further retrieve the geographical map data from the database server 106 for performing the step of route determination 404 for the ridesharing requests 402. In an embodiment, the retrieved geographical map data may correspond to a multi-tier location data that may comprise a hierarchal discretization of a geographical region. For example, the multi-tier location data may comprise three entities, such as a plurality of grids, a plurality of landmarks, and a plurality of clusters, into which the geographical region is divided. The application server 108 may utilize the multi-tier location data for facilitating route determination 404 for the ridesharing requests 402.

Thereafter, the application server 108 may perform the step of vehicle identification 406 for the ridesharing requests 402. The application server 108 may use the one or more greedy algorithms for the identification of the ridesharing vehicle for the ridesharing requests 402. The application server 108 may match one of the ridesharing requests of the first plurality of commuters 104 with the remaining ridesharing requests of the first plurality of commuters 104 based on the corresponding set of commuter constraints and the set of vehicle constraints. Thereafter, based on the matching the application server 108 may identify the ridesharing vehicle for the matched ridesharing requests. In an embodiment, the identified ridesharing vehicle may correspond to a ridesharing vehicle merged based on the matched ridesharing requests. For example, the application server 108 may determine that the ridesharing requests of the commuter 104A and the commuter 104C may be matched based on the corresponding set of commuter constraints and the set of vehicle constraints. Thus, the application server 108 identifies one ridesharing vehicle, such as the first ridesharing vehicle 110A, for the matched ridesharing requests of the commuter 104A and the commuter 104C. Further, the application server 108 may determine that the ridesharing request of the commuter 104B is not a match for any other ridesharing request in the ridesharing requests 402. Thus, the application server 108 identifies a dedicated second ridesharing vehicle 110B for serving the ridesharing request of the commuter 104B. In an embodiment, the application server 108 may further match the ridesharing request of the commuter 104B with any other ridesharing request that may be received while the second ridesharing vehicle 110B is serving the ridesharing request of the commuter 104B. Thus, the first ridesharing vehicle 110A and the second ridesharing vehicle 110B may be merged for the ridesharing requests received in real time. In a scenario, a ridesharing vehicle is merged for serving ridesharing requests received in real time, the application server 108 may transmit an updated route to be followed by the merged ridesharing vehicle for the pick-up and drop of commuters associated with the ridesharing requests received in real time.

The application server 108 may further perform the steps of fare determination 408A and profit determination 408B for the identified ridesharing vehicles. The application server 108 may use equation (1) for the determination of the fare and equation (3) for the determination of profit earned by the service provider. Thereafter, the application server 108 may be further configured to perform the step of detour discount parameter determination 410 by use of equation (5). The application server 108 may determine the adaptive detour discount factor from the plurality of adaptive detour discount factors based on the maximized key performance parameter associated with the identified ridesharing vehicles (such as the first ridesharing vehicle 110A identified for the ridesharing requests of the commuter 104A and the commuter 104C, and the second ridesharing vehicle 110B identified for the ridesharing request of the commuter 104B). In an embodiment, the key performance parameter may correspond to the profit earned by the service provider of the first ridesharing vehicle 110A and the second ridesharing vehicle 110B. In another embodiment, the service provider may specify another key performance parameter which is to be minimized, such as the number of driver-miles for serving the first plurality of commuters 104. In such a case, the key performance parameter may correspond to the number of driver-miles run by the first ridesharing vehicle 110A and the second ridesharing vehicle 110B to serve the corresponding ridesharing requests.

The application server 108 may further perform the step of route determination 404 and vehicle identification 406 for the ridesharing requests, of the second plurality of commuters 114, in the ridesharing requests 402. The application server 108 may use the determined adaptive detour discount factor for the fare determination 408A and the profit determination 408B for the ridesharing requests of the second plurality of commuters 114. Thereafter, the application server 108 may update the key performance parameter associated with the identified ridesharing vehicles for the matched ridesharing requests among the ridesharing requests of the second plurality of commuters 114. Based on the key performance parameter, the application server 108 may perform the step of detour discount parameter determination 410 to update the determined adaptive detour discount factor by use of equation (7). Thus, the application server 108 may address new ridesharing requests based on the updated adaptive detour discount factor.

In an embodiment, the application server 108 may further determine a likelihood of ridesharing requests that can be matched. Thus, the application server 108 may identify the ridesharing requests that can be matched among each other based on the determined likelihood. For example, the application server 108 may determine that the likelihood of matching a ridesharing request along a first route with a ridesharing request along a second route is “0.9.” Thus, the application server 108 may automatically merge the ridesharing requests along the first route with the ridesharing requests along the second route, without performing the matching. Similarly, the application server 108 may determine that the ridesharing request of a commuter, such as the commuter 104A, may be matched with a ridesharing request of another commuter, such as the commuter 104B with a likelihood of “0.01.” Thus, based on the determined likelihood, the application server 108 may automatically discard the matching between the ridesharing requests of the commuter 104A and the commuter 104B when the ridesharing requests of the commuter 104A and the commuter 104B are received in the defined time interval.

A person having ordinary skill in the art will understand that the abovementioned exemplary scenario is for illustrative purpose and should not be construed to limit the scope of the disclosure.

FIG. 5 illustrates an exemplary graphical user-interface (GUI) presented on a commuter-computing device of a commuter to facilitate real time management of ridesharing services, in accordance with at least one embodiment. FIG. 5 is described in conjunction with FIGS. 1-4.

With reference to FIG. 5, there is shown a snapshot 500 that illustrates an exemplary GUI 502 presented on a display screen of a commuter-computing device in a plurality of commuter-computing devices (such as the first plurality of commuter-computing devices 102 or the second plurality of commuter-computing devices 116) associated with a commuter in a plurality of commuters (such as the first plurality of commuters 104 or the second plurality of commuters 114). The GUI 502 presents a first section 504 and a second section 506. The first section 504 comprises a first display box 508 that presents a “DETOUR DISCOUNT FACTOR,” such as “0.4.” The first section 504 further comprises a second display box 510 that presents “VEHICLE IDENTIFICATION NUMBER,” such as “UJ878,” of a ridesharing vehicle that is identified for the ridesharing request of the commuter. The first section 504 further includes a first button 512A “ACCEPT” and a second button 512B “DECLINE.” The commuter may click on the first button 512A “ACCEPT” to accept the identified ridesharing vehicle for commutation. The commuter may click on the second button 512B “DECLINE” to reject the identified ridesharing vehicle for commutation. The likelihood of the selection of the identified ridesharing vehicle, such as “UJ878,” by the commuter may be influenced based on the adaptive detour discount factor (i.e., “DETOUR DISCOUNT FACTOR,” such as “0.4”) displayed in the first display box 508.

The information presented in the first display box 508 and the second display box 510 may be updated by the application server 108. For instance, the application server 108 may update the adaptive detour discount factor. In such a case, the first display box 508 may display the updated “DETOUR DISCOUNT FACTOR.” At another instance, the commuter may click on the second button 512B “DECLINE” to reject the identified ridesharing vehicle for commutation. In such a case, the application server 108 may identify a new ridesharing vehicle for the ridesharing request of the commuter. Thus, the second display box 510 may display the “VEHICLE IDENTIFICATION NUMBER” of the new ridesharing vehicle identified by the application server 108.

The second section 506 presents a navigational map 514 comprising a route 516 of transit of the ridesharing vehicle that is identified for the ridesharing request of the commuter. The route 516 displays one or more pick up locations, such as a location 520 and another location 522, of one or more commuters associated with matched ridesharing requests for which the ridesharing vehicle is identified. For example, the location 520 may correspond to the location of the commuter and the other location 522 may correspond to a pick up location of another commuter who may be travel with the commuter in the identified ridesharing vehicle. A predicted arrival time of the identified ridesharing vehicle, such as “PREDICTED ARRIVAL TIME INSTANT OF VEHICLE UJ878: 12:15:26 a.m.,” may be also displayed to the commuter as a graphical and/or textual indication in portion 524 of the GUI 502. In an embodiment, the route 516 may be updated by the application server 108, if the ridesharing vehicle “UJ878” is further identified for any ridesharing request received in real time, while the ridesharing vehicle “UJ878” is in transit along the route 516.

A person having ordinary skill in the art will understand that the abovementioned exemplary GUI is for illustrative purpose and should not be construed to limit the scope of the disclosure.

The disclosed embodiments encompass numerous advantages. The disclosure provides a method and a system for real time ridesharing management. The disclosed method provides a means to manage real-time ridesharing requests from a plurality of commuters. The disclosed method further ensures that the number of driver-miles for serving a plurality of commuters is reduced by matching the ridesharing requests based on commuter constraints and vehicle constraints. Thus, resulting in an increase in the profit earned by the service provider. Further, the disclosed method dynamically updates a discount factor (i.e., the adaptive detour discount factor) based on which the commuters are charged for availing the ridesharing service. The adaptive detour discount factor is updated in a manner that the profit earned by the service provider is maximized along with an increase in the likelihood of commuters to opt for the ridesharing service. Thus, the disclosed method provides a solution to the ever increasing traffic congestion along various routes. Further, the disclosed method provides a real time solution to manage the real time ridesharing requests based on factor that the computational time for the execution of the disclosed method ranges from 0.01 seconds to 0.22 seconds (based on experimental data). The disclosed method further accommodates new ridesharing requests with already running ridesharing vehicles, thus providing an optimal use of resources (i.e., ridesharing vehicles).

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for data processing for real time ridesharing management have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of data processing by a computing device for ridesharing management, the method comprising:
receiving, by one or more transceivers in the computing device, a first plurality of ridesharing requests of a first plurality of commuters from a first plurality of commuter-computing devices, wherein a ridesharing request of the first plurality of ridesharing requests comprises at least a set of commuter constraints;
identifying, by one or more processors in the computing device, a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle;
determining, by the one or more processors, an adaptive detour discount factor associated with the identified ridesharing vehicle based on the maximized key performance parameter; and
updating, by the one or more processors, the maximized key performance parameter for matched ridesharing requests in a second plurality of ridesharing requests from a second plurality of commuters based on at least the determined adaptive detour discount factor, wherein the determined adaptive detour discount factor is rendered on a display-screen of a second plurality of commuter-computing devices associated with the second plurality of commuters.

2. The method of claim 1, wherein the ridesharing request of the first plurality of ridesharing requests further comprises a source location and a destination location.

3. The method of claim 1, wherein the set of commuter constraints in a ridesharing request of the first plurality of ridesharing requests comprises at least a waiting time threshold, a detour distance threshold, or a detour time threshold.

4. The method of claim 1, wherein the ridesharing vehicle is further identified based on a corresponding set of vehicle constraints specified by the service provider of the ridesharing vehicle.

5. The method of claim 4, wherein the set of vehicle constraints of the ridesharing vehicle comprises at least a capacity constraint of the ridesharing vehicle.

6. The method of claim 1, wherein the identification of the ridesharing vehicle is further based on a distance to be traveled by the ridesharing vehicle for serving each ridesharing request of the first plurality of ridesharing requests.

7. The method of claim 1, wherein the identification of the ridesharing vehicle is further based on a profitability parameter associated with the ridesharing vehicle for serving each ridesharing request of the first plurality of ridesharing requests.

8. The method of claim 1, wherein the identification of the ridesharing vehicle is further based on an increment in value of a profitability parameter associated with the ridesharing vehicle by serving the matched ridesharing requests of the first plurality of ridesharing requests.

9. The method of claim 8, wherein the identified ridesharing vehicle corresponds to a ridesharing vehicle merged based on the matched ridesharing requests of the first plurality of ridesharing requests.

10. The method of claim 1, wherein the identification, by one or more processors in the computing device, of the ridesharing vehicle in real time, by matching the one of the first plurality of ridesharing requests with remaining of the first plurality of ridesharing requests based on at least the corresponding set of commuter constraints, to minimize another key performance parameter, for the matched ridesharing requests in the first plurality of ridesharing requests.

11. The method of claim 10, wherein the maximized key performance parameter corresponds to rewards acquired by the service provider of a plurality of ridesharing vehicles and the minimized other key performance parameter corresponds to a number of driver-miles for serving the first plurality of commuters.

12. The method of claim 11, wherein the rewards acquired by the service provider are determined based on a fare received from the first plurality of commuters when the first plurality of ridesharing requests is served and a wage factor of a driver associated with the identified ridesharing vehicle.

13. The method of claim 1, wherein a likelihood of selection of the corresponding identified ridesharing vehicle by the second plurality of commuters is influenced based on the adaptive detour discount factor rendered on the display-screen of the second plurality of commuter-computing devices.

14. A system of data processing, by a computing device, for ridesharing management, the system comprising:
one or more processors in the computing device configured to:
receive a first plurality of ridesharing requests of a first plurality of commuters, by use of one or more transceivers in the computing device, from a first plurality of commuter-computing devices, wherein a ridesharing request of the first plurality of ridesharing requests comprises at least a set of commuter constraints;
identify a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle;
determine an adaptive detour discount factor associated with the identified ridesharing vehicle based on the maximized key performance parameter; and
update the maximized key performance parameter for matched ridesharing requests in a second plurality of ridesharing requests from the second plurality of commuters based on at least the determined adaptive detour discount factor, wherein the determined adaptive detour discount factor is rendered on a display-screen of a second plurality of commuter-computing devices associated with the second plurality of commuters.

15. The system of claim 14, wherein the ridesharing request of the first plurality of ridesharing requests further comprises a source location and a destination location, and wherein the set of commuter constraints in a ridesharing request of the first plurality of ridesharing requests comprises at least a waiting time threshold, a detour distance threshold, or a detour time threshold.

16. The system of claim 15, wherein the ridesharing vehicle is further identified based on a corresponding set of vehicle constraints specified by the service provider of the ridesharing vehicle.

17. The system of claim 14, wherein the identification of the ridesharing vehicle is further based on a distance to be traveled by the ridesharing vehicle for serving each ridesharing request of the first plurality of ridesharing requests.

18. The system of claim 14, wherein the identification of the ridesharing vehicle is further based on a profitability parameter associated with the ridesharing vehicle for serving each ridesharing request of the first plurality of ridesharing requests.

19. The system of claim 14, wherein the identification of the ridesharing vehicle is further based on an increment in value of a profitability parameter associated with the ridesharing vehicle by serving the matched ridesharing requests of the first plurality of ridesharing requests.

20. A computer program product for use with a computer, the computer program product comprising a non-transitory computer readable medium, wherein the non-transitory computer readable medium stores a computer program code for data processing for real time ridesharing management, wherein the computer program code is executable by one or more processors in a computing device to:
receive a first plurality of ridesharing requests of a first plurality of commuters from a first plurality of commuter-computing devices, wherein a ridesharing request of the first plurality of ridesharing requests comprises at least a set of commuter constraints;
identify a ridesharing vehicle in real time, by matching one of the first plurality of ridesharing requests with remaining of the first plurality of ridesharing requests based on at least the corresponding set of commuter constraints, to maximize a key performance parameter, for the matched ridesharing requests in the first plurality of ridesharing requests, as specified by a service provider of the ridesharing vehicle;
determine an adaptive detour discount factor associated with the identified ridesharing vehicle based on the maximized key performance parameter; and
update the maximized key performance parameter for matched ridesharing requests in a second plurality of ridesharing requests from the second plurality of commuters based on at least the determined adaptive detour discount factor, wherein the determined adaptive detour discount factor is rendered on a display-screen of a second plurality of commuter-computing devices associated with the second plurality of commuters.
